(19) United States
(12) Patent Application Publication
(10) Pub. No.: US 2025/0246965 A1
(43) Pub. Date: Jul. 31, 2025

(54) MOTOR AND MANUFACTURING METHOD OF MOTOR

(71) Applicant: NIDEC CORPORATION, Kyoto (JP)

(72) Inventors: Shota KOMURO, Kyoto (JP); Shintaro SAEKI, Kyoto (JP)

(21) Appl. No.: 19/037,368

(22) Filed: Jan. 27, 2025

(30) Foreign Application Priority Data
Jan. 31, 2024 (JP) 2024-013055

(51) Int. Cl. H02K 3/52; H02K 11/33; H02K 15/32; H02K 21/22

(52) U.S. Cl. CPC H02K 3/522; H02K 11/33; H02K 15/32; H02K 21/22; H02K 2203/06; H02K 2211/03

(57) ABSTRACT

A lead wire of a coil group of a motor penetrates a through hole of a circuit board, an exposed portion of the lead wire is electrically connected to a wiring pattern, and a cover seals the exposed portion of the lead wire.

### CROSS-REFERENCE TO RELATED APPLICATIONS

The present application claims priority under 35 U.S.C. § 119 to Japanese Patent Application No. 2024-013055, filed on Jan. 31, 2024, the entire contents of which are hereby incorporated herein by reference.

### 1. FIELD OF THE INVENTION

The present invention relates to motors and methods of manufacturing motors.

### 2. BACKGROUND

Some conventional motors have configurations in which a conductive wire drawn from a coil is connected to a circuit board via a through hole, and a material for sealing the through hole is filled.

When the gap between the through hole and the conductive wire is small, it may be difficult to fill the through hole with a material for sealing the through hole, and therefore the through hole cannot be sealed, moisture may enter, and corrosion may occur.

### SUMMARY

An example embodiment of a motor of the present invention includes a rotor that is rotatable about a center axis, a stator including a plurality of coil groups arranged on a plurality of teeth opposed in a radial direction to the rotor, and a circuit board that is connected to each of the coil groups to drive the coil groups. Each of the coil groups includes at least one coil defined by one continuous conductive wire, and a lead wire provided at an end of the conductive wire and including an exposed portion from which a conductive portion is exposed. The circuit board includes a wiring pattern on at least one surface in a thickness direction to define a circuit, a through hole penetrating in a thickness direction, and a cover covering at least the wiring pattern. The lead wire penetrates the through hole, and the exposed portion of the lead wire is electrically connected to the wiring pattern. The cover seals the exposed portion of the lead wire.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic cross-sectional view of a motor of an example embodiment of the present disclosure.

FIG. 2 is a schematic perspective view of a stator of an example embodiment of the present disclosure.

FIG. 3 is a view showing a connection state of a plurality of coil groups of an example embodiment of the present disclosure.

FIG. 4 is a schematic view showing a structure of a conductive wire of an example embodiment of the present disclosure.

FIG. 5 is a schematic perspective view of a coupling portion in which common wires are brought together of an example embodiment of the present disclosure.

FIG. 6 is an enlarged cross-sectional view of a stator core to which the coupling portion is fixed, cut along with a plane including a center axis.

FIG. 7 is a bottom view of a circuit board of an example embodiment of the present disclosure as viewed from axially downward.

FIG. 8 is an enlarged cross-sectional view of a state where a U-phase land is attached with a U-phase lead wire of an example embodiment of the present disclosure.

FIG. 9 is a flowchart of a manufacturing process of a motor of an example embodiment of the present disclosure.

FIG. 10 is a schematic view showing a state where the common wire is inserted into a solder bath of an example embodiment of the present disclosure.

FIG. 11 is a schematic view showing a state where the lead wire is inserted into the solder bath.

FIG. 12 is a cross-sectional view of a motor of Modification 1 of an example embodiment of the present disclosure.

FIG. 13 is a cross-sectional view of a motor of Modification 2 of an example embodiment of the present disclosure.

FIG. 14 is a cross-sectional view of a motor of Modification 3 of an example embodiment of the present disclosure.

FIG. 15 is a schematic perspective view showing a stator of the motor shown in FIG. 14.

### DETAILED DESCRIPTION

Hereinafter, motor assemblies according to example embodiments of the present invention will be described with reference to the drawings. Note that the scope of the present invention is not limited to the example embodiments described below, but can be changed within the scope of the technical ideas of the present invention.

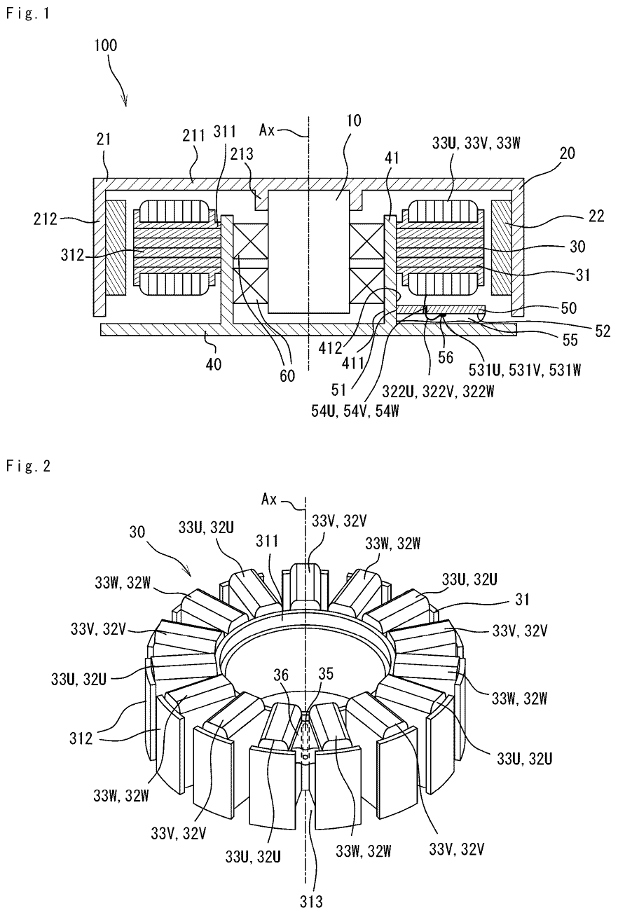

In the present description, a direction parallel to a center axis Ax of a shaft 10 of a motor 100 is an “axial direction”. A direction orthogonal to the center axis Ax is a “radial direction”, and a circumference direction about the center axis Ax is a “circumferential direction”. Based on the state shown in FIG. 1 below, an upper side is called axially upward, and the opposite side is described as axially downward.

In the present description, an “annular shape” includes a shape seamlessly continuous over an entire region in a circumferential direction about the center axis Ax, and a shape having one or more cuts in a part of the entire region about the center axis Ax. It also includes a shape drawing a closed curve in a curved surface intersecting the center axis Ax about the center axis Ax.

Furthermore, in the present description, a “parallel direction” includes not only a completely parallel direction but also a substantially parallel direction. When something “extends along” a predetermined direction or a plane, that includes not only a case of extending strictly in the predetermined direction but also a case of extending in a direction inclined at less than 45° with respect to the strict direction. In addition, “perpendicular” and “orthogonal” include not only a state where both intersect each other at 90 degrees but also a state where they are substantially perpendicular and a state where they are substantially orthogonal, respectively. That is, “parallel”, “perpendicular”, and “orthogonal” each include a state where the positional relationship between both has an angular deviation to an extent without departing from the gist of the present invention.

Note that these are names used merely for description, and do not limit the actual positional relationship, direction, name, and the like.

Hereinafter, the motor 100 according to one exemplary example embodiment of the present invention will be described with reference to the drawings. FIG. 1 is a schematic cross-sectional view of the motor 100 of the one example embodiment. FIG. 1 shows a cross-sectional structure when the motor 100 is virtually cut along with a plane including the center axis.

As shown in FIG. 1, the motor 100 includes the shaft 10, a rotor 20, a stator 30, a base plate 40, a circuit board 50, and a bearing 60. The motor 100 is what is called an outer rotor type brushless DC motor.

The shaft 10 extends in the axial direction along the center axis Ax and has a columnar shape about the center axis Ax. At least a part of the shaft 10 is arranged inside a holding portion 41 described later of the base plate 40 and is rotatably supported by the holding portion 41 via the bearing 60. That is, the shaft 10 is a rotation axis rotatable about the center axis Ax. In the motor 100, the shaft 10 may be a fixed axis fixed to the base plate 40. In this case, the bearing 60 is arranged between the shaft 10 and the rotor 20, and the rotor 20 is rotatably supported with respect to the shaft 10.

As shown in FIG. 1, the rotor 20 includes a rotor case 21 and a rotor magnet 22. The rotor case 21 has a covered tubular shape formed of a magnetic material, and includes a rotor hub 211 and a rotor tube portion 212.

The rotor hub 211 has a rotor boss 213 having a tubular shape extending axially downward from a center portion in the radial direction. The rotor hub 211 has a flat plate shape extending in the radial direction. The rotor boss 213 has a cylindrical shape extending along the center axis Ax, and a center line thereof overlaps the center axis Ax. An end of axially upward of the shaft 10 is fixed to the rotor boss 213. Due to this, the shaft 10 and the rotor case 21 are fixed.

Here, the rotor boss 213 and the shaft 10 are fixed by press-fitting, but the present invention is not limited to this. As a fixing method of the rotor boss 213 and the shaft 10, for example, a method of firmly fixing the rotor boss 213 to the shaft 10, such as adhesion, welding, or screwing, can be widely adopted. Due to this, the rotor 20 is fixed to the shaft 10. Thus, the rotor 20 rotates about the center axis Ax.

The rotor tube portion 212 has a cylindrical shape and extends axially downward from a radial outer edge of the rotor hub 211. A plurality of the rotor magnets 22 are fixed to an inner peripheral surface of the rotor tube portion 212. The plurality of rotor magnets 22 have a cylindrical shape. The rotor magnets 22 are opposed in the radial direction by surrounding the stator 30 (in particular, a stator core 31 described later) from radially outward. The plurality of rotor magnets 22 are arranged in the circumferential direction. Magnetic poles (S pole and N pole) radially inward of the rotor magnets 22 adjacent to each other in the circumferential direction are alternately different. Although the rotor 20 is configured to include the plurality of rotor magnets 22, it is also possible to adopt a magnet having a cylindrical shape in which the magnetic poles of the inner peripheral surface are alternately arranged in the circumferential direction in the N pole and the S pole.

As described above, the rotor tube portion 212 having a cylindrical shape is formed of a magnetic material, and when the inner peripheral surface is attached with the rotor magnet 22, the rotor tube portion 212 serves as a rotor yoke.

FIG. 2 is a schematic perspective view of the stator 30. As shown in FIGS. 1 and 2, the stator 30 includes the stator core 31, an insulator (not shown), and a plurality of coil groups 32U, 32V, and 32W. The stator core 31. s a laminate in which electromagnetic steel plates are laminated in the axial direction. The stator core 31 is not limited to a laminate in which the electromagnetic steel plates are laminated, and may be a single member such as powder firing or casting.

The stator core 31 includes a core back 311 having an annular shape and a plurality of teeth 312. An inner peripheral surface 310 of the core back 311 having an annular shape is fixed to the holding portion 41 of the base plate 40. Due to this, the center of the stator core 31 overlaps the center axis Ax of the motor 100. Note that a fixing member may be interposed between the core back 311 and the holding portion 41.

The plurality of teeth 312 extend radially outward from an outer peripheral surface of the core back 311. The plurality of teeth 312 are arranged at equal intervals in the circumferential direction. The outer peripheral surface of the plurality of teeth 312 are opposed in the radial direction to the inner peripheral surface of the rotor magnet 22 of the rotor 20. The insulator is formed of a material having an insulating property such as a resin, for example.

The stator 30 includes the plurality of coil groups 32U, 32V, and 32W arranged on the plurality of teeth 312 opposed in the radial direction to the rotor 20. In the motor 100, by supplying the coil groups 32U, 32V, and 32W with currents having different phases at appropriate timings, attractive force or repulsive force is generated with the rotor magnet, and the rotor 20 rotates. The plurality of coil groups are defined as a U-phase coil group 32U, a V-phase coil group 32V, and a W-phase coil group 32W, and currents supplied to the respective coil groups are defined as a U-phase current IU, a V-phase current IV, and a W-phase current IW.

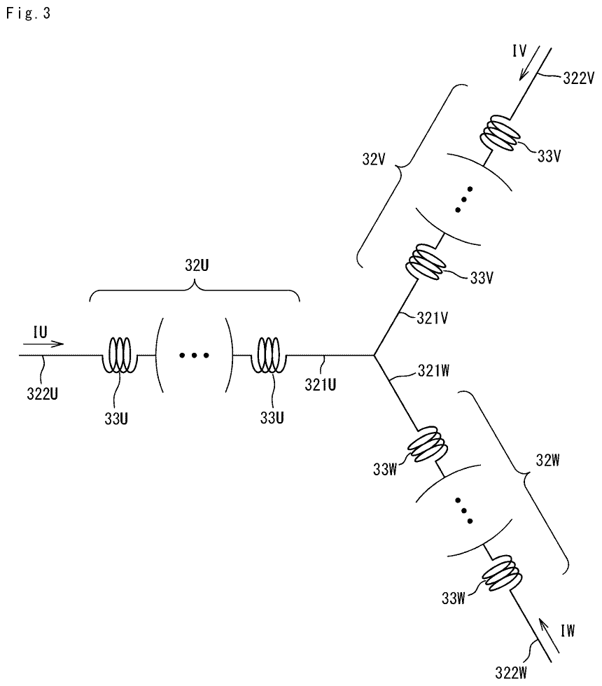

FIG. 3 is a view showing the connection state of the plurality of coil groups 32U, 32V, and 32W. As shown in FIG. 3, the stator 30 has a configuration having 15 teeth 312, and the U-phase coil group 32U has five coils 33U. In the U-phase coil group 32U, the five coils 33U are connected in series. The V-phase coil group 32V has five coils 33V. In the V-phase coil group 32V, the five coils 33V are connected in series. The W-phase coil group 32W has five coils 33W. In the W-phase coil group 32W, the five coils 33W are connected in series. That is, the coil groups 32U, 32V, and 32W include at least one coil 33U, 33V, and 33W, respectively, formed of one conductive wire 34 that is continuous.

One of the conductive wires 34 extending from both ends of the U-phase coil group 32U to which the coils 33U are connected in series is a U-phase common wire 321U, and the other is a U-phase lead wire 322U. Similarly, one of the conductive wires 34 at both ends of the V-phase coil group 32V is a V-phase common wire 321V, and the other is a V-phase lead wire 322V. One of the conductive wires 34 at both ends of the W-phase coil group 32W is a W-phase common wire 321W, and the other is a W-phase lead wire 322W. That is, the coil groups 32U, 32V, and 32W include the common wires 321U, 321V, and 321W provided at the end of the conductive wire 34 and exposing a conductive portion 341.

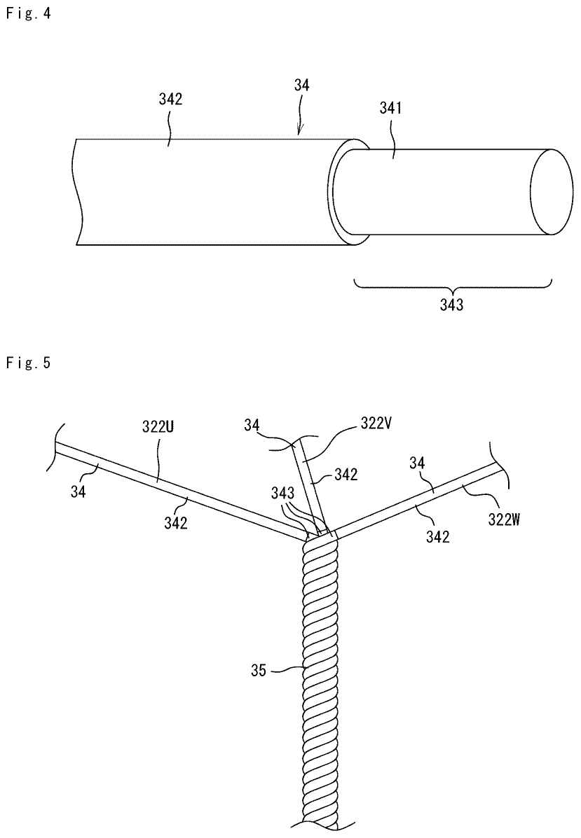

Each of the coils 33U, 33V, and 33W is formed by winding a conductive wire around the teeth 312 covered with an insulator (not shown). FIG. 4 is a schematic view showing the structure of the conductive wire 34. As shown in FIG. 4, the conductive wire 34 includes the conductive portion 341 and an insulation coating 342. The conductive wire 34 has a configuration in which the outer peripheral surface of the conductive portion 341 is covered with the insulation coating 342. Examples of the conductive wire 34 can include what is called an enameled wire in which the conductive portion 341 made of copper is covered with the insulation coating 342 made of enamel resin, but is not limited to this. As the conductive wire 34, a conductive wire in which an outer peripheral part of a conductive member having low resistance is covered with a member having an insulating property can be widely adopted.

The coil 33U and the coil 33U, the coil 33V and the coil 33V, and the coil 33W and the coil 33W are each coupled by the conductive wire 34. A conductive wire connecting the coils, what is called a jumper wire, is attached to an attachment portion (not shown) formed on the insulator. This can suppress a slack of the jumper wire, and can suppress the jumper wire that is slack from coming into contact with the shaft 10 and the rotor 20 and being disconnected.

In the motor 100, the U-phase common wire 321U of the U-phase coil group 32U, the V-phase common wire 321V of the V-phase coil group 32V, and the W-phase common wire 321W of the W-phase coil group 32W are connected. That is, in the motor 100, the three coil groups 32U, 32V, and 32W are star-connected. The U-phase common wire 321U, the V-phase common wire 321V, and the W-phase common wire 321W are electrically connected by a coupling portion 35 in a collective manner. Details of the coupling portion 35 will be described later.

Tips of the U-phase lead wire 322U, the V-phase lead wire 322V, and the W-phase lead wire 322W have an exposed portion 343 from which the insulation coating 342 is removed. That is, the coil groups 32U, 32V, and 32W include lead wires 322U, 322V, and 322W provided at the end of the conductive wire 34 and having the exposed portion 343 where the conductive portion 341 is exposed. Then, soldered portions 323U, 323V, and 323W in which the surface of the exposed portion 343 is attached with the solder are formed. Then, the soldered portions 323U, 323V, and 323W are electrically connected by solder 56 to lands 531U, 531V, and 531W provided on the circuit board 50. Details of the connection of the U-phase lead wire 322U, the V-phase lead wire 322V, and the W-phase lead wire 322W to the circuit board 50 will be described later.

The base plate 40 has a flat plate shape extending in a direction orthogonal to the center axis Ax. The base plate 40 is arranged more axially downward than the rotor 20 and the stator 30. The base plate 40 has the holding portion 41 having a tubular shape extending upward along the axial direction at a center portion in the radial direction. The holding portion 41 and the base plate 40 are formed integrally. Note that the holding portion 41 may be formed separately from the base plate 40, and the holding portion 41 may be fixed to the base plate 40.

Two bearings 60 arranged side by side in the axial direction are arranged on an inner peripheral surface 411 of the holding portion 41, and the two bearings 60 rotatably support the shaft 10 with respect to the holding portion 41. The stator core 31 is fixed to the holding portion 41 in a state where the inner peripheral surface of the core back 311 of the stator core 31 is in contact with an outer peripheral surface 412 of the holding portion 41. Here, the fixing method of the holding portion 41 and the core back 311 is press-fitting. However, the fixing method of the holding portion 41 and the core back 311 is not limited to press-fitting, and a fixing method that can firmly fix the holding portion 41 and the core back 311, such as adhesion, welding, fusion, and screwing, can be widely adopted.

FIG. 5 is a schematic perspective view of the coupling portion 35 in which the common wires 321U, 321V, and 321W are brought together. As shown in FIG. 5, the insulation coating 342 is removed from the tips of the U-phase common wire 321U, the V-phase common wire 321V, and the W-phase common wire 321W, and the tips are twisted. Then, the conductive portion 341 of the tip of each of the common wires 321U, 321V, and 321W having been twisted and integrated is soldered to form the coupling portion 35. That is, in order to electrically connect the plurality of common wires 321U, 321V, and 321W and to configure the coupling portion 35 by coupling the common wires 321U, 321V, and 321W, which have a configuration in which the plurality of common wires 321U, 321V, and 321W are soldered, by soldering, the coupling portion 35 can electrically connect the common wires 321U, 321V, and 321W in the coupling portion 35.

The U-phase common wire 321U, the V-phase common wire 321V, and the W-phase common wire 321W are electrically connected via the coupling portion 35. That is, the stator 30 includes the coupling portion 35 in which the common wires 321U, 321V, and 321W of the plurality of coil groups 32U, 32V, and 32W are electrically connected and coupled.

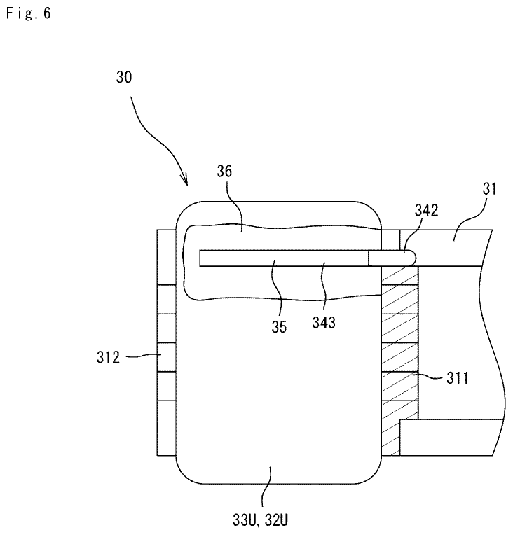

Here, fixing of the coupling portion 35 to the stator core 31 will be described. FIG. 6 is an enlarged cross-sectional view of the stator core 31 to which the coupling portion 35 is fixed, cut along with a plane including the center axis Ax.

As shown in FIGS. 2 and 6, the coupling portion 35 is arranged inside a slot 313 formed between the teeth 312 adjacent to each other in a circumferential direction. More specifically, since the motor 100 of the present example embodiment is an outer rotor motor, the stator core 31 has the teeth 312 extending radially outward from the core back 311 arranged radially inward. Therefore, the common wires 321U, 321V, and 321W are continuous to the respective coils radially inward in the stator core 31. The coupling portion 35 extends from the radial inside to the radial outside in the slot 313. That is, the coupling portion 35 is positioned radially outward toward the tip. The coupling portion 35 may be arranged at a twisted position with respect to the center axis Ax.

That is, the coupling portion 35 extends from the radial inside to the radial outside in the slot 313, which is a part between the teeth 312 adjacent to each other in the circumferential direction. The coupling portion 35 may be configured to extend in a direction intersecting the center axis Ax. Furthermore, the coupling portion 35 may be in the radial direction about the center axis Ax.

In the stator 30, the U-phase common wire 321U, the V-phase common wire 321V, and the W-phase common wire 321W are arranged in an axially upper portion. Therefore, as shown in FIG. 5, the coupling portion 35 in which the common wires are twisted and brought together is arranged in the axially upper portion in the slot 313.

As described above, the conductive wire 34 constituting the coupling portion 35 is soldered by removing the insulation coating 342 arranged on the outer periphery. When the part soldered to the coupling portion 35 is exposed, corrosion, what is called rust, may occur due to the influence of external moisture. In particular, in the case of the motor 100 operated in a high temperature and high humidity environment, rust of the coupling portion 35 is likely to occur. Therefore, the motor 100 includes a sealing portion 36 that seals the coupling portion 35. That is, the stator 30 of the motor 100 includes the sealing portion 36 that seals at least the coupling portion 35.

Here, the sealing portion 36 will be described. The sealing portion 36 is a member that covers the coupling portion 35. Examples of the sealing portion 36 include a resin formed of a material that suppresses passage of moisture. This suppresses moisture from the outside from reaching the coupling portion 35. Examples of the sealing portion 36 include an ultraviolet curable resin that has a property of suppressing passage of moisture and is cured by ultraviolet irradiation, a thermosetting resin cured by heating, and a resin cured by a chemical reaction. Since the sealing portion 36 is formed of a resin, the coupling portion 35 can be easily sealed. Therefore, the number of components can be reduced, and the number of steps in the manufacturing process can be reduced.

The sealing portion 36 is arranged between both ends in a direction along the center axis Ax of the coils 330 and 33V. With such a configuration, the sealing portion 36 does not protrude more outward than both ends in both directions on the center axis Ax of the stator 30. This suppresses contact between the rotor 20 and the sealing portion 36. The coupling portion 35 is arranged to be shifted to one side in a direction along the center axis Ax relative to the center portion in the direction along the center axis Ax. Therefore, the sealing portion 36 is arranged on one side in the direction along the center axis Ax relative to the center portion in the direction along the center axis Ax in the slot 313. With such a configuration, when the sealing portion 36 is formed after the coupling portion 35 is arranged inside the slot 313, the sealing portion 36 is formed in a part close to an opening in the axial direction of the slot 313, and thus the periphery of the coupling portion 35 is easily filled with the resin. As a result, the sealing portion 36 can be easily formed.

Then, the sealing portion 36 covers the coupling portion 35 and is fixed to the coils 330 and 33V wound around the teeth 312 adjacent to the slot 313. The sealing portion 36 may be fixed to the teeth 312. That is, the sealing portion 36 is fixed to the teeth 312 adjacent to each other in a circumferential direction to the slot 313 in which the sealing portion 36 is arranged or the coils 33U and 33V arranged in the teeth 312. Due to this, since the coupling portion 35 is fixed, movement of the coupling portion 35 is suppressed during operation of the motor 100, and the contact of the coupling portion 35 with the rotor 20 is suppressed. In the motor 100, the coupling portion 35 may be arranged at the axially lower end of the slot 313.

By configuring the coupling portion 35 and the sealing portion 36 as described above, it is possible to suppress moisture from adhering to the coupling portion 35 by the sealing portion 36. This can suppress corrosion of the coupling portion 35 due to adhesion of moisture. Such a configuration makes it possible to provide the motor 100 that can be used even in a place where moisture easily adheres to the coupling portion 35 and a place where dew condensation easily occurs.

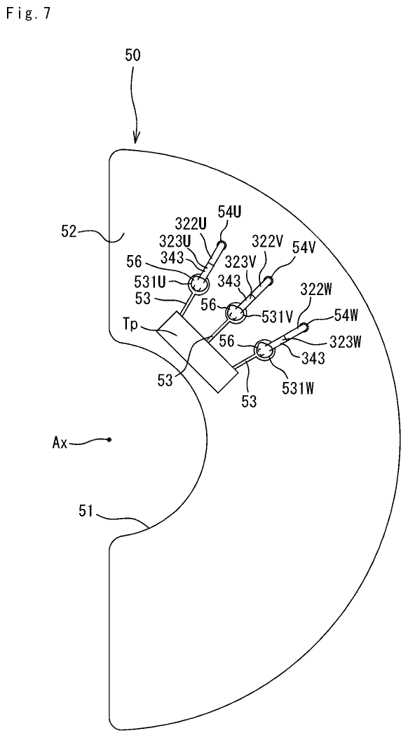

FIG. 7 is a bottom view of the circuit board 50 as viewed from axially downward. As shown in FIG. 1, the circuit board 50 is arranged between the stator core 31 of the holding portion 41 and the base plate 40. As shown in FIG. 7, the circuit board 50 has a plate shape with a semicircular outer shape. The outer periphery of the circuit board 50 has a linear part and an arcuate part. An attachment portion 51 having a recess shape is formed in a center part of the linear part of the circuit board 50. The circuit board 50 is fixed to the holding portion 41 by the attachment portion 51 coming into contact with the outer peripheral surface 412 of the holding portion 41. Note that the circuit board 50 of the present example embodiment may have a ring shape.

An axially lower surface of the circuit board 50 is a pattern surface 52, and a wiring pattern 53 made of a conductive film having conductivity is formed on the pattern surface 52. The wiring pattern 53 is mounted with a plurality of electronic components Tp to form the circuit. That is, the circuit board 50 includes the wiring pattern 53 formed on at least one surface in the thickness direction to define the circuit. The electronic components Tp are arranged on the pattern surface 52, and are surface-mounted, in which terminals are electrically connected to the pattern wiring. The mounting of the electronic components Tp is not limited to surface mounting, and may be through hole mounting.

A motor drive circuit includes a control circuit, a driver circuit, and an inverter circuit, and supplies the U-phase coil group 32U, the V-phase coil group 32V, and the W-phase coil group 32W with the U-phase current IU, the V-phase current IV, and the W-phase current IW, respectively, at appropriate current values and timings (phases) based on signals from the outside that instruct the rotational speed and torque of the motor 100. That is, the circuit board 50 is connected to the coil groups 32U, 32V, and 32W to drive the coil groups 32U, 32V, and 32W, respectively.

As shown in FIG. 7, the circuit board 50 includes through holes 54U, 54V, and 54W penetrating in the thickness direction. The U-phase lead wire 322U penetrates the through hole 54U. The V-phase lead wire 322V penetrates the through hole 54V. The W-phase lead wire 322W penetrates the through hole 54W. That is, the lead wires 322U, 322V, and 322W penetrate the through holes 54U, 54V, and 54W.

The wiring pattern 53 includes the U-phase land 531U, the V-phase land 531V, and the W-phase land 531W. The U-phase land 531U is arranged at a position away from the through hole 54U, the V-phase land 531V is arranged at a position away from the through hole 54V, and the W-phase land 531W is arranged at a position away from the through hole 54W. That is, the through holes 54U, 54V, and 54W are arranged avoiding the wiring pattern 53.

The lead wires 322U, 322V, and 322W are drawn to the positions away from the through holes 54U, 54V, and 54W, and the exposed portions 343 of the lead wires 322U, 322V, and 322W are brought into contact with and fixed to the wiring patterns 531U, 531V, and 531W. By doing this, at least a part of the exposed portions 343 of the lead wires 322U, 322V, and 322W may be in contact with the wiring patterns 531U, 531V, and 531W, and thus the exposed portion 343 can be shortened.

The exposed portion 343 of the U-phase lead wire 322U is electrically connected to the U-phase land 531U, the exposed portion 343 of the V-phase lead wire 322V is electrically connected to the V-phase land 531V, and the exposed portion 343 of the W-phase lead wire 322W is electrically connected to the W-phase land 531W. That is, exposed portions 343 of the lead wires 322U, 322V, and 322W are electrically connected to the wiring pattern 53. A motor drive circuit is connected to the U-phase land 531U, the V-phase land 531V, and the W-phase land 531W.

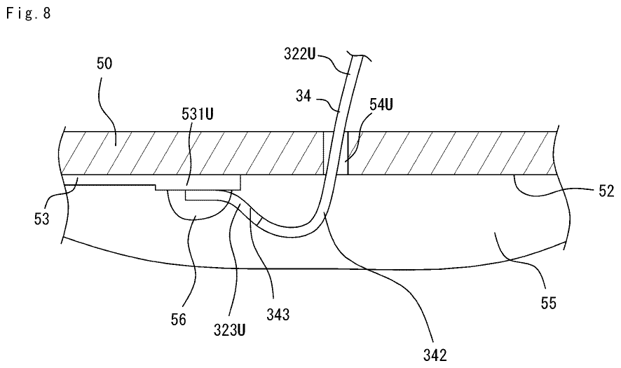

Next, a connection state between the U-phase lead wire 322U, the V-phase lead wire 322V, and the W-phase lead wire 322W and the U-phase land 531U, the V-phase land 531V, and the W-phase land 531W will be described with reference to the drawing. The U-phase lead wire 322U, the V-phase lead wire 322V, and the W-phase lead wire 322W have the same configuration. The U-phase land 531U, the V-phase land 531V, and the W-phase land 531W have the same configuration. Therefore, the description will be representatively made with reference to the U-phase lead wire 322U and the U-phase land 531U. FIG. 8 is an enlarged cross-sectional view of a state where the U-phase lead wire 322U is attached to the U-phase land 531U.

As shown in FIG. 8, the stator core 31 is arranged axially upward with respect to the circuit board 50. Therefore, the U-phase lead wire 322U is wired from axially upward to downward of the circuit board 50. The U-phase lead wire 322U penetrates the through hole 54U formed in the circuit board 50 from axially upward to axially downward.

The exposed portion 343 from which the insulation coating 342 is removed is formed at the tip of the U-phase lead wire 322U. Due to this, the exposed portion 343 at the tip of the U-phase lead wire 322U is arranged outside the through hole 54U. The outer surface of the exposed portion 343 at the tip of the U-phase lead wire 322U is covered with solder to form the soldered portion 323U. Then, the soldered portion 323U is brought into contact with the U-phase land 531U and electrically connected by solder. Similarly, the V-phase lead wire 322V and the W-phase lead wire 322W are electrically connected to the V-phase land 531V and the W-phase land 531W. With this configuration, the U-phase coil group 32U is supplied with the U-phase current IU via the U-phase land 531U and the U-phase lead wire 322U. Similarly, the V-phase coil group 32V is supplied with the V-phase current IV, and the W-phase coil group 32W is supplied with the W-phase current IW.

The circuit board 50 includes a cover 55. The cover 55 covers at least the wiring pattern 53 of the circuit board 50. In the circuit board 50 according to the present example embodiment, the cover 55 is configured to cover the entire surface of the pattern surface 52. The cover 55 seals the exposed portions 343 of the lead wires 322U, 322V, and 322W.

The cover 55 is made of, for example, a resin. Due to this, the cover 55 can have a shape that matches the wiring pattern 53 formed on the circuit board 50.

This makes it possible to suppress adhesion of foreign matters such as water, dust, or dirt to the wiring pattern 53 and the U-phase lead wire 322U, the V-phase lead wire 322V, and the W-phase lead wire 322W attached to the wiring pattern 53. Such a configuration makes it possible to provide the motor 100 that can be used even in a place where moisture easily adheres to the coupling portion and a place where dew condensation easily occurs.

Note that the cover 55 is not limited to a resin, and a configuration that has insulating properties and can reliably cover the wiring pattern 53 can be widely adopted. In the motor 100 according to the present example embodiment, the cover 55 is made of a flowable resin, and may be configured by causing the resin to flow to the pattern surface 52 of the circuit board 50 and then curing the resin.

A part covered with the insulation coating 342 of the conductive wire 34 constituting the U-phase lead wire 322U is arranged inside the through hole 54U. Similarly, a part covered with the insulation coating 342 of the conductive wire 34 constituting the V-phase lead wire 322V is arranged inside the through hole 54V. A part covered with the insulation coating 342 of the conductive wire 34 constituting the W-phase lead wire 322W is arranged inside the through hole 54W. That is, the parts covered with the insulation coating 342 of the conductive wire 34 of the lead wires 322U, 322V, and 322W are arranged inside the through holes 54U, 54V, and 54W.

With such a configuration, since the exposed portions 343 of the conductive wire 34 are not arranged in the through holes 54U, 54V, and 54W, even when moisture flows into the through holes 54U, 54V, and 54W, adhesion of moisture to the U-phase lead wire 322U, the V-phase lead wire 322V, and the W-phase lead wire 322W is suppressed, and corrosion is suppressed. Furthermore, even when the inner diameters of the through holes 54U, 54V, and 54W are small and the resin constituting the cover 55 does not flow, corrosion of the U-phase lead wire 322U, the V-phase lead wire 322V, and the W-phase lead wire 322W is suppressed.

As shown in FIG. 8, the shortest distance between the U-phase land 531U and the through hole 54U is longer than the length of the exposed portion 343 formed at the tip of the U-phase lead wire 322U. The shortest distance between the V-phase land 531V and the through hole 54V is longer than the length of the exposed portion 343 formed at the tip of the V-phase lead wire 322V. The shortest distance between the W-phase land 531W and the through hole 54W is longer than the length of the exposed portion 343 formed at the tip of the W-phase lead wire 322W. That is, shortest distances between the wiring patterns 531U, 531V, and 531W to which the exposed portions 343 of the lead wires 322U, 322V, and 322W are connected and the through holes 54U, 54V, and 54W through which the lead wires 322U, 322V, and 322W penetrate are longer than lengths of the exposed portions 343 of the lead wires 322U, 322V, and 322W.

With this configuration, the exposed portion 343 of the conductive wire 34 constituting the U-phase lead wire 322U, the V-phase lead wire 322V, and the W-phase lead wire 322W can be suppressed from being arranged in the through holes 54U, 54V, and 54W. The exposed portion 343 is arranged at a position overlapping the pattern surface 52 of the circuit board 50 in the axial direction. As a result, the exposed portion 343 can be reliably sealed when the cover 55 is arranged, and corrosion due to adhesion of moisture to the exposed portion 343 can be suppressed.

In the motor 100 of the present example embodiment, the circuit board 50 is arranged between the stator 30 and the base plate 40, but the present invention is not limited to this. For example, the circuit board 50 may be arranged on the side opposite to the base plate 40 across the stator 30 in the axial direction.

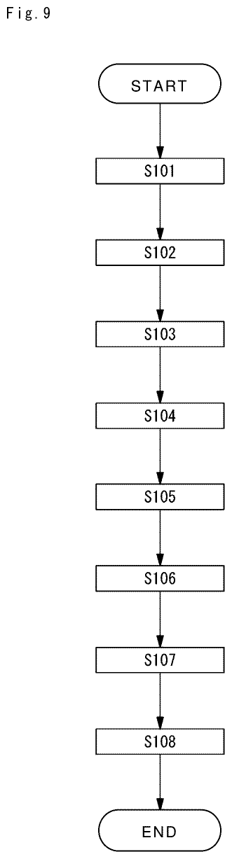

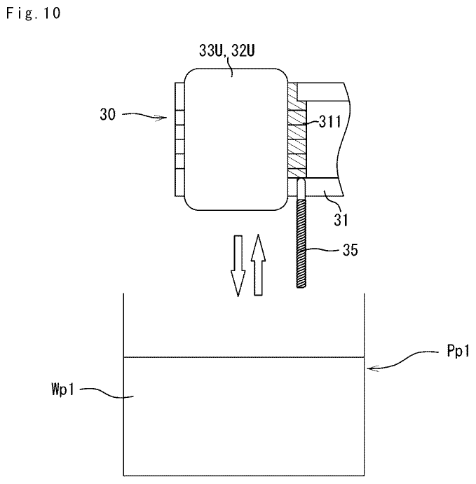

A manufacturing method of the motor 100 will be described with reference to the drawings. FIG. 9 is a flowchart showing the manufacturing process of the motor 100. As shown in FIG. 9, in the manufacturing process of the motor 100, first, a coil group generation step (step S101) is performed in which the conductive wire 34 is wound around the plurality of teeth 312 extending in the radial direction of the stator core 31 to generate the coil groups 32U, 32V, and 32W. After step S101, in the manufacturing process of the motor 100, a coupling portion generation step (step S102) is executed in which the insulation coating 342 at the end of the conductive wire 34 of the coil groups 32U, 32V, and 32W is removed to generate the common wires 321U, 321V, and 321W in which the conductive portions 341 are exposed, the conductive portions 341 of the common wires 321U, 321V, and 321W are brought into contact with each other, and the coupling portion 35 is generated by soldering. In the case that the soldering is performed on the part where the common wires 321U, 321V, and 321W are in contact with each other, the common wires 321U, 321V, and 321W brought together in a solder bath Pp1 filled with molten solder Wp may be inserted (see FIG. 10).

After step S102, in the manufacturing process of the motor 100, a coupling portion arrangement step (step S103) of arranging the coupling portion 35 in a state of extending from the radial inside to the radial outside or vice versa in the slot 313, which is a part between the teeth 312 adjacent to each other in a circumferential direction is executed. At this time, the coupling portion 35 is arranged to extend from the radial inside toward the radial outside. After step S103, in the manufacturing process of the motor 100, a sealing portion generation step (step S104) of causing a flowable resin to flow into the part of the slot 313 where the coupling portion 35 is arranged and solidifying the resin to generate the sealing portion 36 is executed.

After step S104, in the manufacturing process of the motor 100, a lead wire generation step (step S105) of generating the lead wires 322U, 322V, and 322W having the exposed portions 343 in which the conductive portion 341 is exposed by removing the insulation coating 342 at the end of the conductive wire 34 of the coil groups 32U, 32V, and 32W is executed.

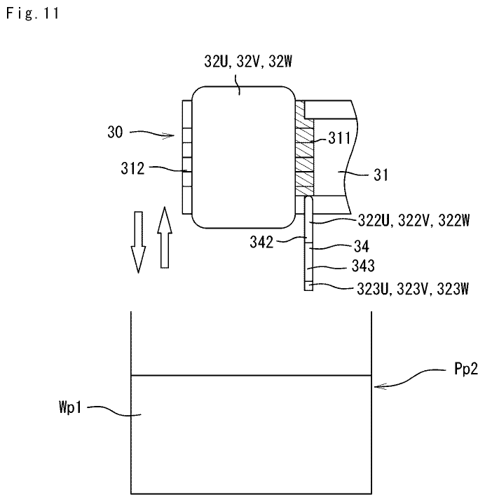

After step S105, in the manufacturing process of the motor 100, a soldered portion generation step (step S106) of immersing a part of the tip of the exposed portion 343 of each of the lead wires 322U, 322V, and 322W into the solder bath Pp2 filled with the molten solder Wp to generate the soldered portions 323U, 323V, and 323W is executed (see FIG. 11). The lengths of the soldered portions 323U, 323V, and 323W can be, for example, about 5 mm or less.

After step S106, in the manufacturing process of the motor 100, a circuit connection step (step S107) is executed in which the soldered portions 323U, 323V, and 323W are inserted into the through holes 54U, 54V, and 54W formed in the circuit board 50, and the exposed portion 343 is soldered to the wiring patterns 531U, 531V, and 531W formed in the circuit board 50.

After step S107, in the manufacturing process of the motor 100, a cover generation step (step S108) of generating a cover 55 covering the pattern surface 52 of the circuit board 50 is executed. The cover 55 may be configured to cover at least the wiring pattern 53.

In the present example embodiment, steps S105 to S108 are performed after steps S102 to S104, but the opposite may be performed. They may be simultaneous.

In the manufacturing method of the motor 100 in the above-described process, the coil groups 32U, 32V, and 32W of the stator 30 are formed, the coupling portion 35 is generated and then soldered, and the sealing portion 36 is generated. Therefore, even if variations due to the shape and dimensions of the motor 100 occur, the coupling portion 35 can be reliably sealed. This can suppress corrosion due to adhesion of moisture to the coupling portion 35.

Since the coil groups 32U, 32V, and 32W of the stator 30 are formed, and the lead wires 322U, 322V, and 322W are generated, and then soldering, through hole mounting, and generation of the cover 55 are performed, the exposed portions 343 of the lead wires 322U, 322V, and 322W can be reliably sealed even if variations due to the shape and dimensions of the motor 100 occur. This can suppress corrosion due to adhesion of moisture to the lead wires 322U, 322V, and 322W.

Since the U-phase land 531U, the V-phase land 531V, and the W-phase land 531W are arranged away from the through holes 54U, 54V, and 54W, the lead wires 322U, 322V, and 322W may penetrate the through holes 54U, 54V, and 54W. Therefore, the soldered portions 323U, 323V, and 323W may be short. The length of each of the soldered portions 323U, 323V, and 323W can be, for example, about 5 mm. By shortening the lengths of the soldered portions 323U, 323V, and 323W, it is possible to suppress the stator 30 from coming into contact with the solder bath Pp2 when the exposed portions 343 at the tips of the lead wires 322U, 322V, and 322W are immersed in the solder bath Pp2 in which the molten solder Wp is stored. This enables the soldered portions 323U, 323V, and 323W to be manufactured safely.

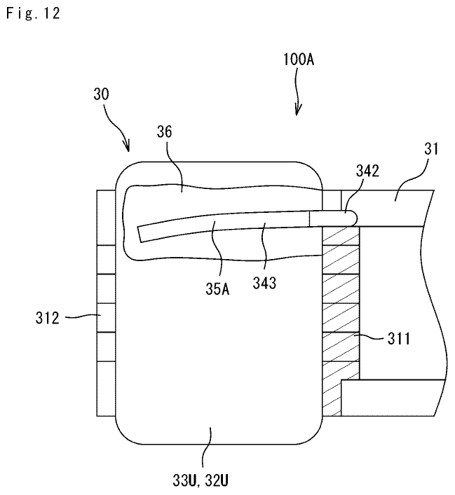

As shown in the motor 100A of FIG. 12, a coupling portion 35A may be configured such that the radially outward is arranged axially downward the radially inward. FIG. 12 is a cross-sectional view of a motor 100A of Modification 1. When the coupling portion 35A is arranged in the axially lower end of the slot 313, the radially outward may be arranged radially upward from the radially inward.

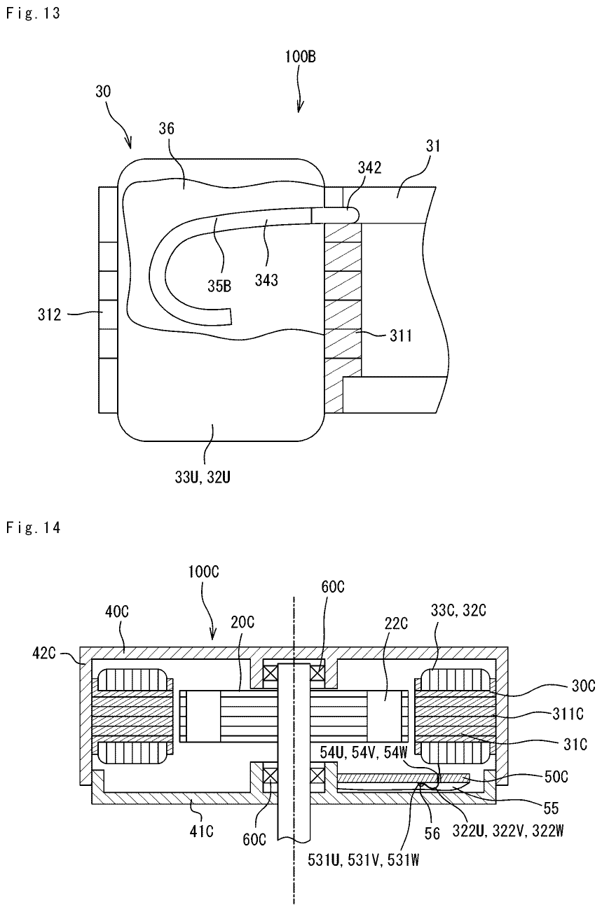

As shown in a motor 100B of FIG. 13, a coupling portion 35B may have a portion curved axially downward radially outward, and a part of the tip may extend radially inward. FIG. 13 is a cross-sectional view of the motor 100B of Modification 2. When the coupling portion 35B is arranged in the axially lower end of the slot 313, the coupling portion 35B may be curved upward and a part of the tip may extend radially inward.

With such configurations of the motor 100A and the motor 100B, even if the lengths of the coupling portions 35A and 35B are longer than the radial length of the slot 313, they can be accommodated in the slot 313. Due to this, the entire coupling portions 35A and 35B can be sealed by the sealing portion 36, and corrosion of the coupling portions 35A and 35B due to moisture can be suppressed.

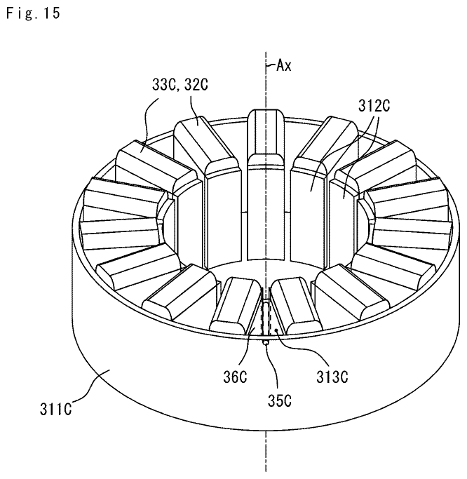

FIG. 14 is a cross-sectional view of a motor 100C of Modification 3. FIG. 15 is a schematic perspective view showing a stator 30C of the motor 100C shown in FIG. 14. As shown in FIG. 14, the motor 100C includes a shaft 10C, a rotor 20C, a stator 30C, a housing 40C, a circuit board 50C, and a bearing 60C.

The motor 100C includes the housing 40C, and the housing 40C includes a base plate 41C and a housing body 42C. The housing body 42C has a covered tubular shape, and in the motor 100C, the housing body 42C has a tubular shape extending along the axial direction. The axially upper end of the housing body 42C has a lid portion expanding radially inward. The axially lower end of the housing body 42C is attached with the base plate 41C. The housing body 42C is fixed to the base plate 41C.

The motor 100C is an inner rotor type DC brushless motor, and the stator 30C is fixed to the inner peripheral surface of the housing body 42C. The shaft 10C fixed to the rotor 20C is supported rotatably about the center axis Ax by the lid portion of the housing body 42C and the base plate 41C via the bearing 60C.

As shown in FIG. 15, the stator 30C includes a stator core 31C and a plurality of coil groups 32C. The plurality of coil groups 32C have the same configuration as the U-phase coil group 32U, the V-phase coil group 32V, and the W-phase coil group 32W described above. Each of the coil groups 32C has the same number of coils 33C.

As shown in FIG. 15, the stator core 31C includes a core back 311C and a plurality of teeth 312C. The core back 311C has a tubular shape. The plurality of teeth 312C extend radially inward from the core back 311C. That is, a coupling portion 35C extends radially inward from the radial outward in a slot 313C, which is a part between the teeth 312C adjacent to each other in a circumferential direction.

The common wire of each of the coil groups 32C is arranged in an insulator (not shown) arranged in the core back 311C, and the coupling portion 35C where the common wires are soldered collectively is arranged in the slot 313C formed between the teeth 312C adjacent to each other in the circumferential direction. The coupling portion 35C extends radially inward from radially outward in the slot 313C. The coupling portion 35C is sealed by a sealing portion 36C made of a resin or the like, and is fixed to the coil 33C arranged in the teeth 312C adjacent to the slot 313C in the circumferential direction by the sealing portion 36C.

The coupling portion 35C is arranged at an axially upper end or lower end of the slot 313C. With this configuration, when the resin is poured to form the sealing portion 36C, the resin can be reliably spread around the coupling portion 35C. This makes it possible to reliably seal the coupling portion 35C, suppress adhesion of moisture to the coupling portion 35C, and suppress corrosion due to adhesion of moisture.

In the examples described above, the motors 100, 100A, 100B, and 100C are brushless DC motors, but are not limited to this, and are not particularly limited as long as they are motors having a configuration in which coils are arranged on the stator.

The present invention has the following configurations.

(1) A motor including:
a rotor that rotates about a center axis;
a stator including a plurality of coil groups arranged on a plurality of teeth opposed in a radial direction to the rotor; and
a circuit board that is connected to each of the coil groups and drives the coil group; wherein
each of the coil groups includes:
   at least one coil defined by one continuous conductive wire; and
   a lead wire provided at an end of the conductive wire and including an exposed portion from which a conductive portion is exposed;
the circuit board includes:
   a wiring pattern provided on at least one surface in a thickness direction to define a circuit;
   a through hole penetrating in a thickness direction; and
   a cover covering at least the wiring pattern;
the lead wire penetrates the through hole, and the exposed portion of the lead wire is electrically connected to the wiring pattern; and
   the cover seals the exposed portion of the lead wire.

(2) The motor according to (1), in which a portion covered with an insulation coating of the conductive wire of the lead wire is inside the through hole.

(3) The motor according to (1) or (2), in which the through hole is arranged to avoid the wiring pattern.

(4) The motor according to (3), in which a shortest distance between the wiring pattern to which the exposed portion of the lead wire is connected and the through hole through which the lead wire penetrates is longer than a length of the exposed portion of the lead wire.

(5) The motor according to any of (1) to (4), in which the cover is made of a resin.

(6) A manufacturing method of a motor, the manufacturing method including:
generating a plurality of coil groups by winding a conductive wire around a plurality of teeth extending in a radial direction of a stator;
generating a lead wire including an exposed portion where a conductive portion is exposed by removing an insulation coating of an end of a conductive wire of each of the plurality of coil groups;
generating a soldered portion by immersing at least a portion of a tip of the exposed portion of the lead wire into a solder bath filled with molten solder;
inserting the soldered portion into a through hole defined on a circuit board and soldering the exposed portion to a wiring pattern formed on the circuit board; and
   generating a cover covering at least the wiring pattern of the circuit board.

(7) The manufacturing method of a motor according to (6), in which a length of the soldered portion is about 5 mm or less.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor that is rotatable about a center axis;
a stator including a plurality of coil groups arranged on a plurality of teeth opposed in a radial direction to the rotor; and
a circuit board that is connected to each of the coil groups and drives the coil group; wherein
each of the coil groups includes:
at least one coil defined by one continuous conductive wire; and
a lead wire provided at an end of the conductive wire and including an exposed portion from which a conductive portion is exposed;
the circuit board includes:
a wiring pattern provided on at least one surface in a thickness direction to define a circuit;
a through hole penetrating in a thickness direction; and
a cover covering at least the wiring pattern;
the lead wire penetrates the through hole, and the exposed portion of the lead wire is electrically connected to the wiring pattern; and
the cover seals the exposed portion of the lead wire.

2. The motor according to claim 1, wherein a portion covered with an insulation coating of the conductive wire of the lead wire is inside the through hole.

3. The motor according to claim 1, wherein the through hole is arranged to avoid the wiring pattern.

4. The motor according to claim 3, wherein a shortest distance between the wiring pattern to which the exposed portion of the lead wire is connected and the through hole through which the lead wire penetrates is longer than a length of the exposed portion of the lead wire.

5. The motor according to claim 1, wherein the cover is made of a resin.

6. A manufacturing method of a motor, the manufacturing method comprising:
providing a plurality of coil groups by winding a conductive wire around a plurality of teeth extending in a radial direction of a stator;
providing a lead wire including an exposed portion where a conductive portion is exposed by removing an insulation coating of an end of a conductive wire of each of the plurality of coil groups;
providing a soldered portion by immersing at least a portion of a tip of the exposed portion of the lead wire into a solder bath filled with molten solder;
inserting the soldered portion into a through hole in a circuit board and soldering the exposed portion to a wiring pattern on the circuit board; and
providing a cover covering at least the wiring pattern of the circuit board.

7. The manufacturing method of a motor according to claim 6, wherein a length of the soldered portion is about 5 mm or less.
